(19) United States
(12) Patent Application Publication
(10) Pub. No.: US 2008/0140725 A1
(43) Pub. Date: Jun. 12, 2008

(54) Bracelet, network and database for emergency medical situations

(76) Inventors: Lisa Gunn-Beshears, Elizabethtown, KY (US); Heath Plum, Bardstown, KY (US)

Correspondence Address: STOCKWELL & SMEDLEY, PSC, 861 CORPORATE DRIVE, SUITE 200, LEXINGTON, KY, 40503, US

(21) Appl. No.: 11/999,542

(22) Filed: Dec. 6, 2007

Related U.S. Application Data
(60) Provisional application No. 60/873,435, filed on Dec. 7, 2006.

(51) Int. Cl. G06F 17/30

(52) U.S. Cl. 707/104.1; 707/E17.005

(57) ABSTRACT

A wearable identification and information device can be purchased by an individual and can be used to retrieve previously disclosed information regarding the individual and their health status. The device can be unobtrusively worn by the individual and bears a code, or other data, that is used to search a remote database accessible through the Internet or other communications networks. The remote database includes specific medical information related to the wearer of the device associated with that code.

### RELATED APPLICATION

The present application claims priority to Provisional Patent Application Ser. No. 60/873,435 filed Dec. 7, 2006, the contents of which are incorporated herein by reference, in their entirety.

### FIELD OF THE INVENTION

The present invention relates to a medical information system and, more particularly, to a user-wearable device in conjunction with a medical information system.

### BACKGROUND OF THE INVENTION

Situations, such as, for example, medical emergencies sometimes happen where the patient is not able to provide pertinent medical information, contact information, prescription information, or explain that he has special medical needs. Consequently, an improved mechanism for conveying medical information in a variety of instances is desired.

### SUMMARY OF THE INVENTION

Embodiments of the present invention relate to a medical information tracking system that includes a) a database configured to store a respective record for each of a plurality of user's wherein each record is associated with a user specific code and has its data organized into a plurality of different tiers, wherein each user specific code corresponds to a user-wearable device; b) an interface configured to receive a particular user specific code from an accessor, wherein the accessor has an associated tier level corresponding to one of the plurality of different tiers; and c) the interface, in response to receiving the particular user specific code, is further configured to output a portion of the record associated with the user specific code that corresponds to the tier level of the accessor.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

FIG. 1 depicts an exemplary environment for embodiments of the present invention.

FIG. 2 depicts potential commercial relationships existing within embodiments of the present invention.

FIG. 3 depicts a block diagram of a tiered structure arranged in accordance with principles of the present invention.

FIG. 4 depicts an exemplary user interface in accordance with the principles of the present invention.

### DETAILED DESCRIPTION OF THE PREFERRED EMBODIMENTS

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

Embodiments of the present invention are related to a wearable identification and information device that can be purchased by an individual and can be used to retrieve previously disclosed information regarding the individual and their health status. The device can be unobtrusively worn by the individual and bears a code, or other data, that is used to search a remote database accessible through the Internet or other communications networks. The remote database includes specific medical information related to the wearer of the device associated with that code.

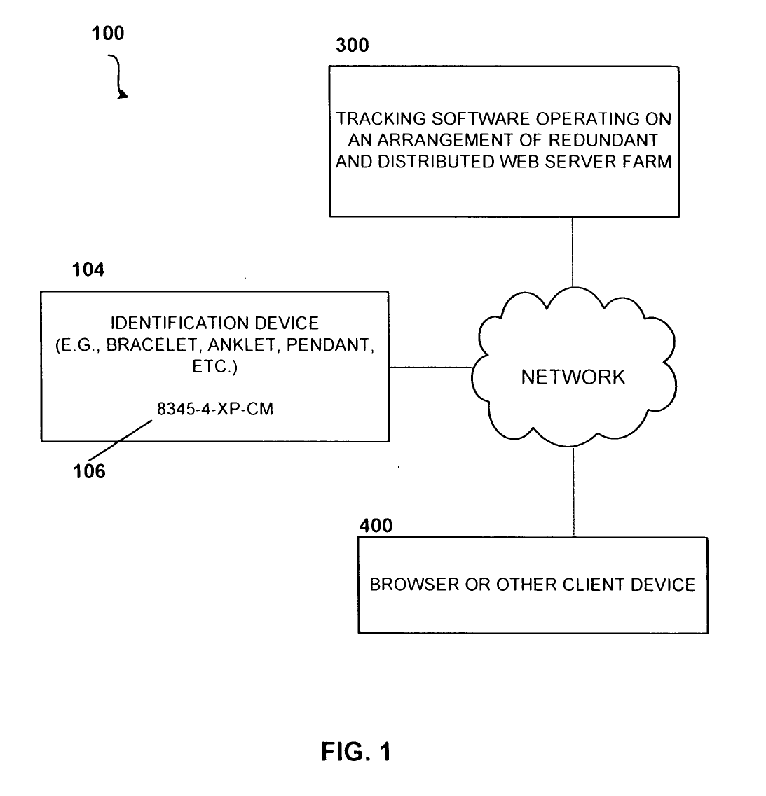

FIG. 1 depicts an exemplary environment for embodiments of the present invention. In its most general terms, the system 100 provides a service by which user specific information is stored and retrievable based on a user specific account code that a user wears on their person. As shown in FIG. 1, the system 100 includes a bracelet 104 that can be worn on a wrist or an ankle and is encoded or engraved with identifying data 106. The identifying data may include a user-specific account code or account name that can be used to retrieve stored data about that user. The identifying information may also include a web address, for example, of a database or other data store from which the stored information may be retrieved. In addition to the bracelet 104, similar information may be stored on a pendant that fits on a necklace or key chain as well. Embodiments of the present invention also contemplate a card (e.g., credit-card sized) encoded with a web address, an account code, and possibly instructions for their use. The encoding of this account code and any other information may be accomplished using printed text, magnetic stripes, smart card technology or any of a variety of functionally equivalent means. Even further, the present invention also contemplates a temporary tattoo that a user can easily apply and remove that includes the user-specific account code and possibly a web, or other similar, address. As shown in FIG. 1, the system 100 can include an Internet-based web service comprising a secure database 300 hosted on a server cluster arrangement that stores specific information associated with each user account code on various bracelets 104 and is accessible by various users via a client interface 400. However, it is to be noted that other communication implementations can also be used, and that the Internet is but one means of implementing the present invention. In other words, the present invention should not be considered as limited exclusively to the technology illustrated herein, but instead will be adaptable to changes and reconfigurations as communication technology itself changes. For example, wireless and cellular communications paths along with traditional network infrastructure can all be used, and used concurrently, in various embodiments of the present invention.

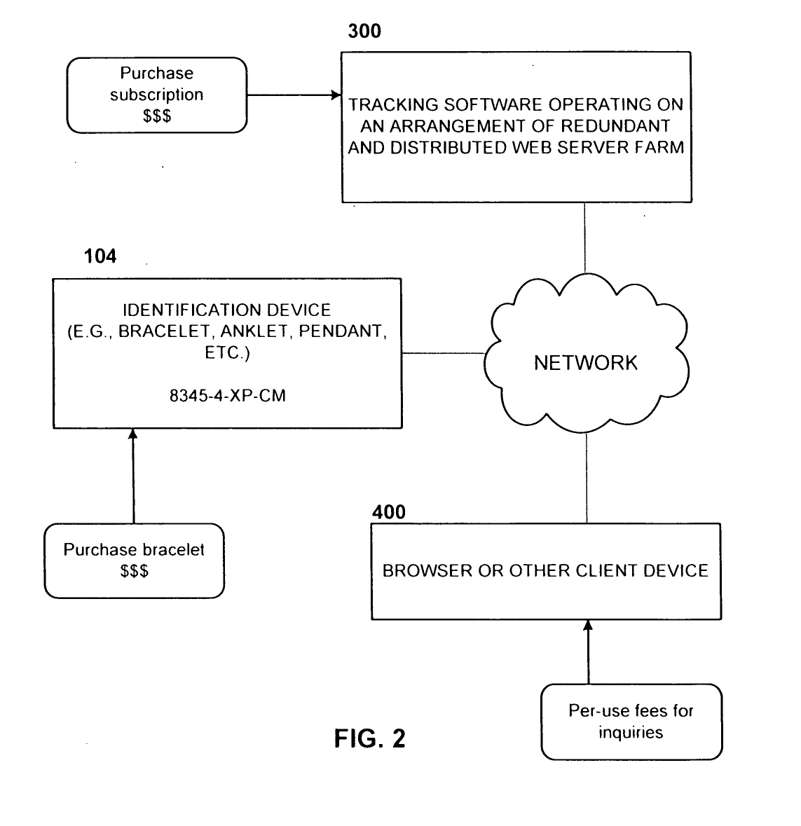

FIG. 2 depicts potential commercial relationships existing within embodiments of the present invention. A user may purchase the product (e.g., bracelet) 104 and activate the accompanying service. Details of how to activate the service may be provided along with the product or made available at a web site or other activation center that the user is directed to use. For example, the user may access, through the Internet, the data storage facility 300 to activate the product. In one example, the user may first initially activate the product with a password supplied with the product and then be allowed, after accepting terms of some user agreement, to change the password to something designated by the user. Afterwards, the user may provide personal and health related information that may be useful in various situations. For example, in an emergency or other similar situation, the user may not be cognizant enough to provide contact information or health related information and in other non-emergency scenarios, the user may simply forget or overlook pertinent information that would aid a medical provider. The user can be guided through a series of templates of questions that are designed to elicit useful health and personal information about the user or the user may be given various fields to simply enter information that they believe is relevant. In all cases, the user need only provide the information which they are comfortable providing.

The purchase and activation of the product 104 can occur in a variety of alternative ways. For example, in one instance, the user purchases the service and once the account activation is completed, the bracelet 104 is inscribed with the account code on it and then mailed to the user. Alternatively, the user can purchase an already inscribed bracelet 104 that becomes useful immediately after completing the product activation routine. In certain embodiments, recurrent fees could be collected from each user such as an annual renewal fee or a monthly service fee.

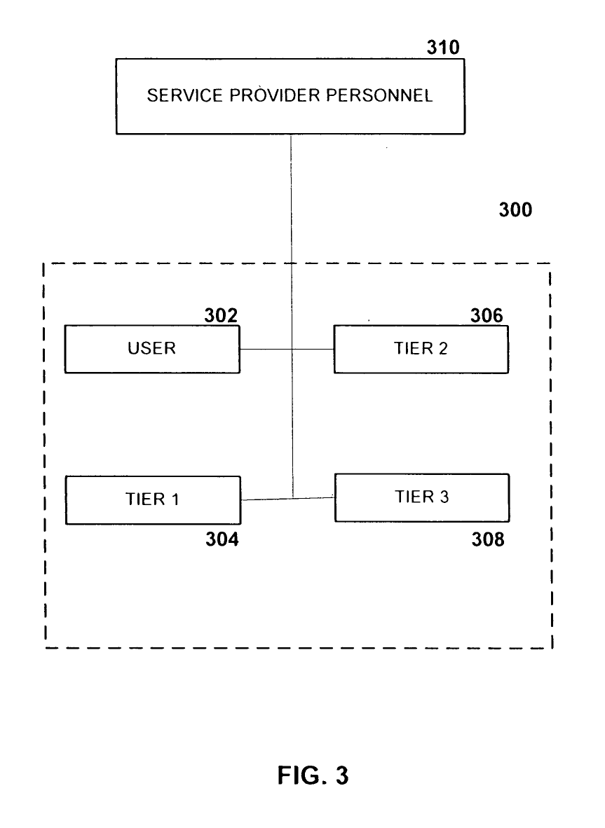

FIG. 3 depicts a block diagram of a tiered structure arranged in accordance with principles of the present invention. As shown in FIG. 1, the data storage facility 300 may include multiple servers for security and reliable service. The identifying data 106 on each wearable device 104 will provide access to the data storage facility 300 where the user's information is stored such as the user's name, basic demographic information, allergies, medical condition/history, medication information, physician and dentist information as well as emergency contact information. One of ordinary skill will recognize that more or less information of this nature may be provided without departing from the scope of the present invention.

Security for accessing the data storage facility 300 can include a variety of known methods. Encryption and other security credentialing techniques can be provided so that only medical or other authorized personnel may access the database 300 and that their access is limited as appropriate to their particular role. For example, the data storage facility 300 may be accessed by the appropriate personnel from any Internet computer, blackberry or Internet-capable phone or by calling 911 by providing authentication information securely identifying that user. Again, the present invention should not be considered as limited solely to these enumerated devices, but will adapt as technology advances and various consumer communication devices come out.

The data storage facility 300 of the system 100 may have, for example, four clearance levels. Various access and subscription fees, possibly in different amounts and configurations, can be collected from user's accessing different tiers of the data storage facility 300.

User access 302 is provided for members to input and update their own information. Embodiments of the present invention may also offer a service for participants who are unable or do not wish to enter their own information. In such an arrangement, service provider personnel 310 would directly contact a user's medical providers in order to provide the initial information for the user as well as keep track of changes in medications and medical conditions, and thus alleviate the need for the wearer to do so.

Tier 1 access 304 may be targeted to non-medical groups such as at RV groups, travel groups, movie theatres, museums, schools, convention groups, and/or retail environments such as WalMart or Target. However, it is to be noted that these groups are provided for exemplary purposes only, and the present invention should not be limited exclusively thereto. Tier 1 data would have no personal medical information, but would provide non medical information such as an emergency contact or user name, for example. This is because there is no expectation of emergency medical care inside a retail environment such as WalMart. However, an insurance underwriter for members of this group may offer a discount or reduction in rates for their premises liability insurance, as a reward for using the system 100. This is because the system 100 can reduce medical risks within a given physical environment, and therefore can reduce the resulting liability that arises whenever such an event occurs. The payment mechanism for purchasing Tier 1 access could be, for example, an annual subscription fee. Per-access charges could also be implemented, although it is desired to not deter a Tier 1 customer from using the present invention based on reluctance to incur an unnecessary cost.

Tier 2 access 306 may be targeted at emergency personnel such as police, fire department, paramedics, emergency rooms, and 911 responders, as well as perhaps other similar entities. Tier 2 clearance can provide basic information, such as name, allergies, medical condition, and emergency contact information. Tier 2 is thus targeted at a more medically sophisticated customer base than Tier 1.

Tier 3 access 308 is the most comprehensive and complex, and is targeted to hospitals, emergency medical services and various government agencies such as FEMA and the 911 system. Tier 3 access can include, for example, information such as date of birth, social security number, postal address, physician information, insurance information, and any other ancillary information the customer wants provided to the client that goes above and beyond the information provided by Tier 2, but might still be useful in an emergency. The subscription fees for Tier 3 access would likely be higher than for the other tiers.

The data storage facility 300 can provide the service such that each device 104 can be set up to have its own separate home page through a specific website such as but not limited to 4eMbrace.com, and further, where each page is set up with various types of encryption for the clients' protection. Thus, as shown in FIGS. 1 and 2 a client browser 400 can access the data storage facility 300 such that the access interface and the user information pages are provided as web pages within the client by visiting the web site (e.g., 4eMbrace.com). The data storage facility 300 may have redundant storage for both security and reliability but the web servers providing access to the data storage facility 300 may also be arranged in a clustered environment that provides speed, reliability, and security. Because the information within data storage facility 300 may be helpful in a critical situation, the data storage facility 300 and its web servers may be replicated in different geographical locations to provide even further reliability, performance and security.

Thus, in operation, each user specific code on a bracelet corresponds to a record within the data storage facility and that record has pieces of information associated with, or organized according to different tier levels. Thus, when a user accesses the data storage facility to retrieve a record, the user specific code determines what record is retrieved and the tier level of the accessor determines which portion of the record is actually disclosed. For example, as described above, a Tier-1 accessor is going to be provided less information than a Tier-3 accessor even though they both access the same record through the system.

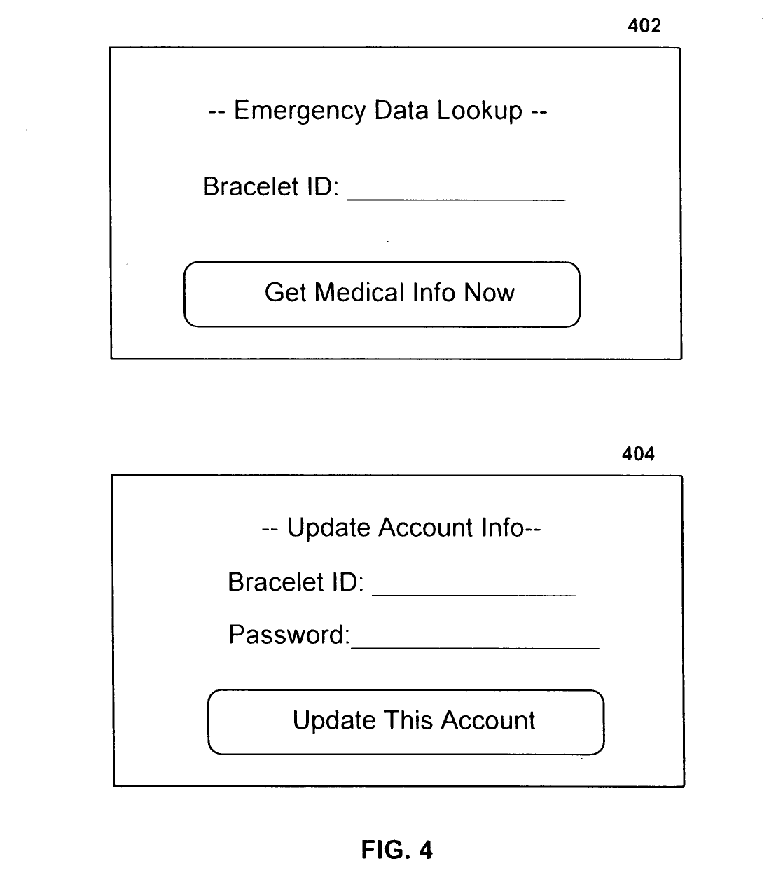

FIG. 4 depicts an exemplary user interface in accordance with the principles of the present invention. As shown in FIG. 4, the web clients 400 which access to the data storage facility 300 are beneficially user friendly for easy access and updating. This is beneficial because, other than member update access, the system 100 of the present invention will be seldom accessed, but when an access does occur, the user will be in an extreme hurry, and will not appreciate a complex interface. Consequently, the interface to the data storage facility 300 is modeled to provide simplicity and predictability. A user will get on, get the information they need (beneficially in less than one minute) and go do what they need to do.

FIG. 4 depicts two different interface screens. In one interface 402, a user accessor includes the user specific code and will, in return, receive the portion of that medical record he is allowed access to based on his Tier level. In the other screen 404, a user can access their own record using their specific code and password. Through this interface, the user can update their record in the data storage facility.

The system 100 of the present invention will allow a user to actively or passively provide easy access in an emergency room, for example, to information that will allow medical personnel to expedite care. It will allow the user to change information accessible through their bracelet 104 (or anklet, necklace, card, etc.) as their health care situation changes, rather than order a new bracelet 104 each time. When used by children, the present invention may help schools during emergencies. The bracelet 104 would also be beneficial for children who get separated from their parent, or elderly suffering from Alzheimer's, etc. In cases of natural disasters or acts of violence, the present invention could help FEMA identify victims and locate their next of kin. Thus, the present invention could provide peace of mind to the client during a crisis. The system 100 may be covered by private insurance, or Medicare/Medicaid. It may also be a tax deductible medical expense.

In some embodiments, a new user's specific account code can be generated by a random number generator or random sequence generator. This is important because a thief or other bad person must be deterred from being able to reason backwards from a user's specific account code to their social security number, telephone number, address, or other vital private information.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed:

1. A medical information tracking system comprising:
a database configured to store a respective record for each of a plurality of user's wherein each record is associated with a user specific code and has its data organized into a plurality of different tiers, wherein each user specific code corresponds to a user-wearable device;
an interface configured to receive a particular user specific code from an accessor, wherein the accessor has an associated tier level corresponding to one of the plurality of different tiers; and
the interface, in response to receiving the particular user specific code, is further configured to output a portion of the record associated with the user specific code that corresponds to the tier level of the accessor.

2. The system of claim 1, wherein the plurality of different tiers includes four tiers.

3. The system of claim 1, wherein the plurality of different tiers is hierarchically arranged such that data in a lower tier is included in a higher tier.

4. The system of claim 3, wherein the portion of the record output corresponds to data in the tier level of the accessor as well as data in any lower tier.

5. The system of claim 1, wherein each of the respective records includes medical-related information

6. The system of claim 5, wherein each of the respective records further includes emergency contact information.

7. The system of claim 6, wherein each of the respective records further includes personal identification information.

8. The system of claim 1, wherein the interface includes a web server in communication with the database.

9. The system of claim 8, wherein the web server provides access to the database for an owner of a device associated with a user specific code, wherein such access permits the owner to modify the respective record associated with that user specific code.

10. The system of claim 1, wherein a first accessor is a medical-care provider and a second accessor is not a medical-care provider and a different, respective tier level is associated with the first and second accessors.

11. The system of claim 10, wherein the tier level associated with the first accessor provides access to more information in the plurality of records than the tier level associated with the second accessor

12. A method for tracking medical information comprising:
storing a respective record for each of a plurality of user's wherein each record is associated with a user specific code and within each record data is organized into a plurality of different tiers, wherein each user specific code corresponds to a user-wearable device;
receiving a particular user specific code from an accessor, wherein the accessor has an associated tier level corresponding to one of the plurality of different tiers; and
in response to receiving the particular user specific code, providing a portion of the record associated with the user specific code that corresponds to the tier level of the accessor.

13. The method of claim 12, wherein the plurality of different tiers is hierarchically arranged such that data in a lower tier is included in a higher tier.

14. The method of claim 13, wherein the portion of the record output corresponds to data in the tier level of the accessor as well as data in any lower tier.

15. The method of claim 12, wherein each of the respective records includes medical-related information

16. The method of claim 15, wherein each of the respective records further includes emergency contact information.

17. The method of claim 16, wherein each of the respective records further includes personal identification information.

18. An apparatus comprising:
a device configured to be carried by a user; and
a user specific code included with the device that is associated with a record for the user stored in a data access facility wherein:
the data access facility is configured to organize the record data according to a plurality of different tiers, wherein when the data access facility receives the user specific code from an accessor having an associated tier level, the data access facility outputs a portion of the record that corresponds to the tier level of the accessor.

19. The apparatus of claim 18, wherein the device further includes a web address corresponding to the data access facility.

20. The apparatus of claim 18, wherein the device is one of a bracelet, necklace, anklet, temporary tattoo, and a card.
